(19) United States
(12) Patent Application Publication
(10) Pub. No.: US 2010/0022286 A1
(43) Pub. Date: Jan. 28, 2010

(54) SLIDING MECHANISM AND PORTABLE ELECTRONIC DEVICE USING THE SAME

(75) Inventors: JIN-XIN WANG, Shenzhen City (CN); CHAO-ZHONG FU, Shenzhen City (CN); JIAN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (TW); HON HAI PRECISION IDUSTRY CO., LTD., Tu-Cheng (TW)

(21) Appl. No.: 12/327,650

(22) Filed: Dec. 3, 2008

(30) Foreign Application Priority Data
Jul. 25, 2008 (CN) 200810303064.3

(51) Int. Cl. H04M 1/00

(52) U.S. Cl. 455/575.4

(57) ABSTRACT

An exemplary sliding mechanism includes a main plate, a slide plate, and a clock spring positioned between the main plate and the slide plate. The slide plate is slidably connected to the main plate. The clock spring includes a first spiral portion fixed to the slide plate, a second spiral portion fixed to the main plate, and a connecting portion connecting the first spiral portion to the second spiral portion. The clock spring is configured for driving the slide plate and enabling the slide plate to slide along the main plate after the slide plate is manually moved to a predetermined position with respect to the main plate.

### BACKGROUND

1. Technical Field

The present invention generally relates to sliding mechanisms and, more particularly, to a sliding mechanism used for a portable electronic device with two or more housings.

2. Discussion of the Related Art

Sliding mechanisms are widely used in portable electronic devices, such as slide-type mobile phones and slide-type personal digital assistants. A typical slide mechanism generally includes a first sheet, a second sheet, and a torsion spring positioned between the first sheet and the second sheet. The first sheet is slidably connected to the second sheet. The torsion spring includes a spiral portion, and a first arm and a second arm extending from the spiral portion. The first arm is fixed to the second sheet, and the second arm is fixed to the first sheet.

In use, the torsion spring provides an elastic force enabling the first plate to slide along the second plate after the first plate is manually moved to a predetermined position with respect to the second plate.

However, when the torsion spring is deformed, the force applied on the torsion spring is concentrated on a portion between the first and second arms and the spiral portion. Thus, the portions between the first and second arms and the spiral portion are easily damaged, and a work life of the sliding mechanism is unduly shortened.

What is needed, therefore, is a sliding mechanism which overcomes the above-described shortcomings.

### BRIEF DESCRIPTION OF THE DRAWINGS

The components in the drawings are not necessarily drawn to scale, the emphasis instead being placed upon clearly illustrating the principles of the present sliding mechanism and portable electronic device. Moreover, in the drawings, like reference numerals designate corresponding parts throughout the several views, and all the views are schematic.

FIG. 1 is an isometric view illustrating a closed state of one embodiment of a sliding-type portable electronic device, the portable electronic device including a first housing, a second housing, and a sliding mechanism.

FIG. 2 is similar to FIG. 1, but showing an opened state of the sliding-type portable electronic device.

FIG. 3 is an assembled, isometric view of an embodiment of the sliding mechanism of the electronic device of FIG. 1, the sliding mechanism including a slide plate, a main plate, a clock spring, and a pair of guiding rails.

FIG. 4 is an exploded, isometric view of the sliding mechanism of FIG. 3.

FIG. 5 is similar to FIG. 4, but viewed from another aspect.

FIG. 6 is an assembled, isometric view of the sliding mechanism of FIG. 4, showing the slide plate in a closed position relative to the main plate.

FIG. 7 is similar to FIG. 6, but showing the slide plate in a half-closed position relative to the main plate.

FIG. 8 is similar to FIG. 6, but showing the slide plate in an open position relative to the main plate.

### DETAILED DESCRIPTION OF THE EMBODIMENTS

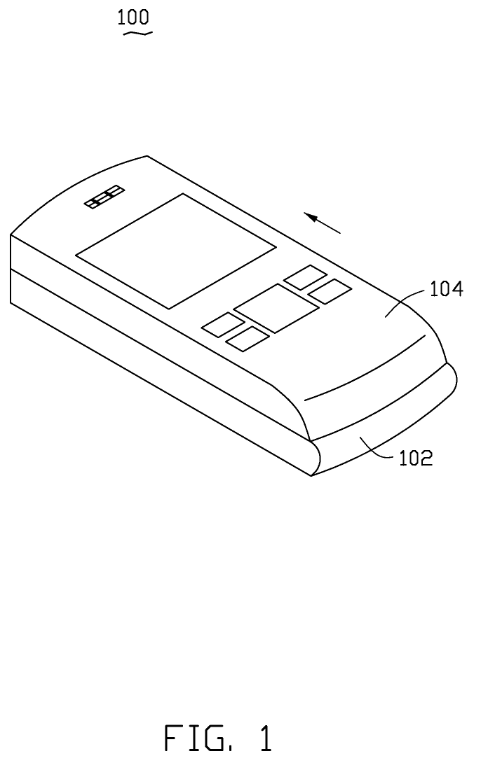

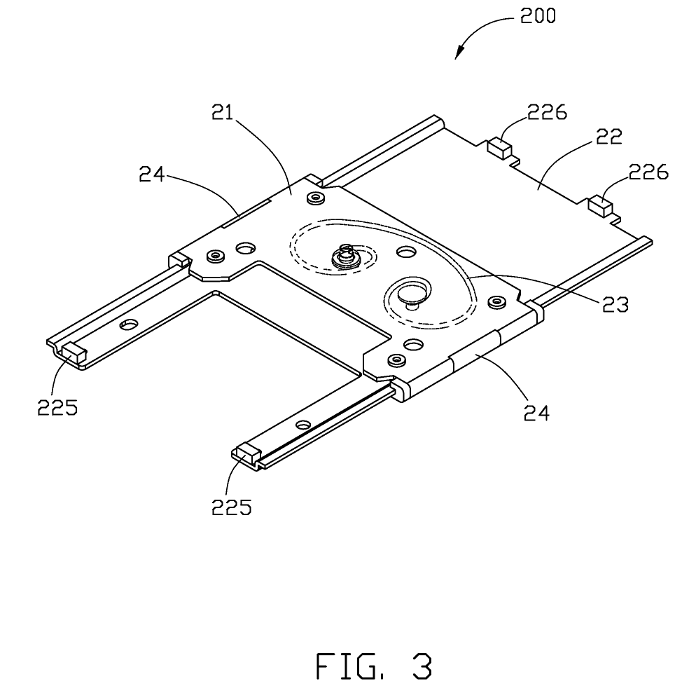

Referring to FIGS. 1 through 3, one embodiment of a sliding mechanism 200 is adapted for use in a portable electronic device 100. The portable electronic device 100 includes a first housing 102, a second housing 104 engaging with the first housing 102, and the sliding mechanism 200. The sliding mechanism 200 is positioned between the first and second housings 102, 104 for making the second housing 104 slidable relative to the first housing 102. The second housing 104 slides relative to the first housing 102, to expose or cover a keypad (not labeled) on the first housing 102.

The sliding mechanism 200 includes a slide plate 21, a main plate 22, a clock spring 23, and a pair of guiding rails 24. The slide plate 21 is slidably connected to the main plate 22. The clock spring 23 is positioned between the slide plate 21 and the main plate 22. An end of the clock spring 23 is fixed to the slide plate 21 and another end is fixed to the main plate 22. The clock spring 23 may be a spiral torsion spring. The clock spring 23 is on substantially a same plane as the main plate 22 and the slide plate 21.

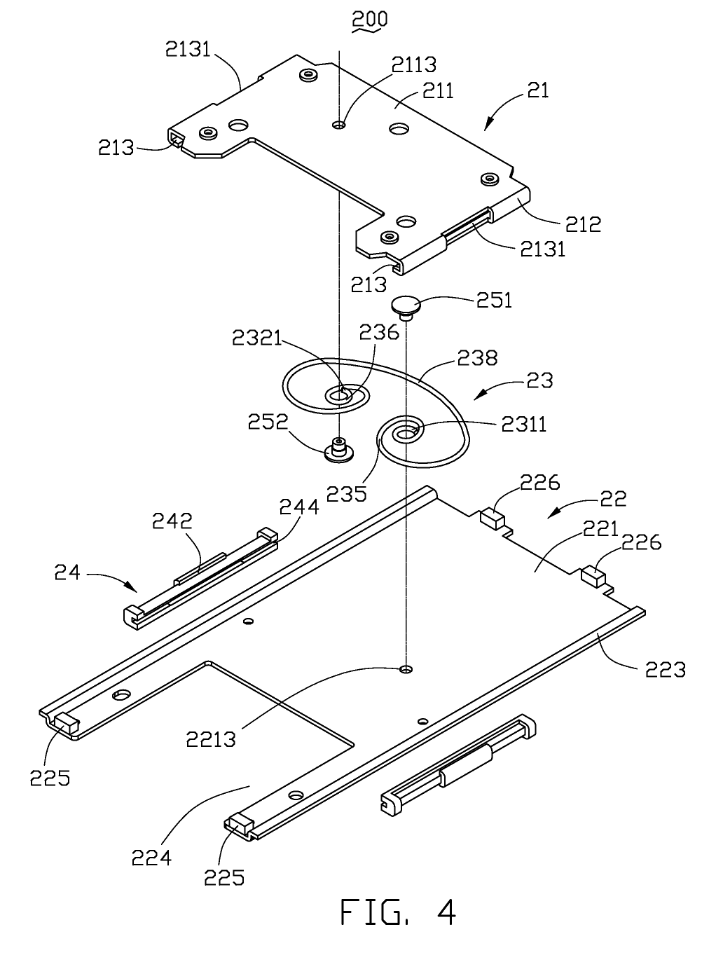

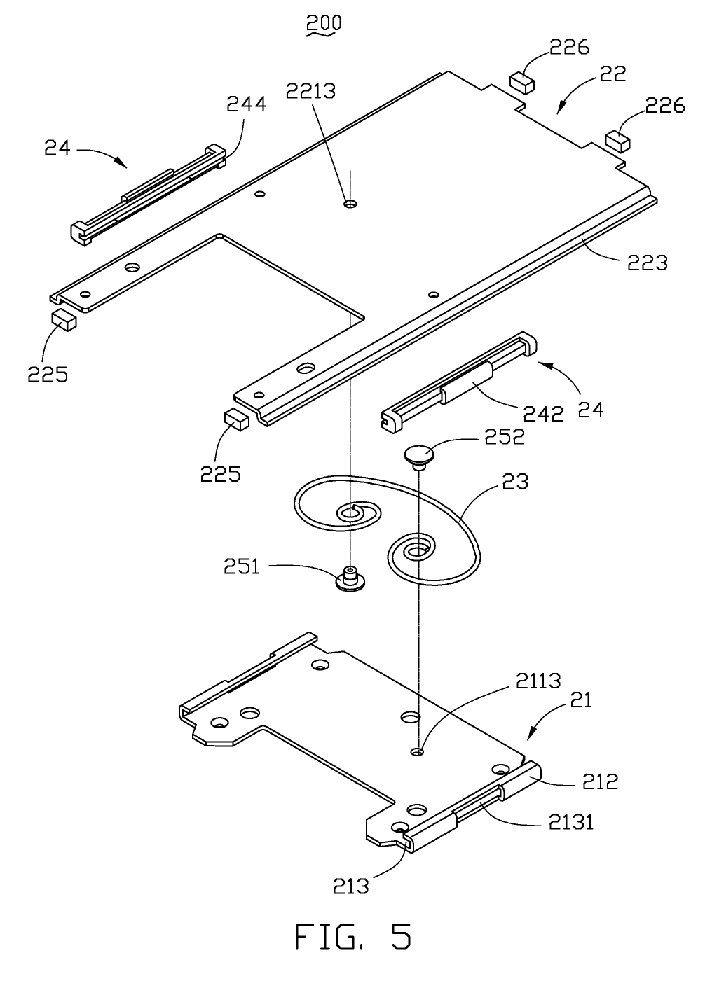

Referring to FIGS. 4 and 5, in the illustrated embodiment, the slide plate 21 of the sliding mechanism 200 is substantially rectangular shaped. The slide plate 21 includes a main portion 211. The slide plate 21 defines an engaging hole 2113 approximately in the main portion 211. A pair of arched sidewalls 212 extend from opposite sides of the main portion 211, thereby defining two receiving grooves 213 for receiving the guiding rails 24 of the sliding mechanism 200. Each sidewall 212 defines a latching hole 2131.

In the illustrated embodiment, the main plate 22 of the sliding mechanism 200 is substantially rectangular shaped. The main plate 22 includes a main body 221 and a pair of slide strips 223 extending from opposite sides of the main body 221. The main body 221 defines an oblong opening 224 adjacent to an end portion and a fixing hole 2213. The oblong opening 224 is configured for assembling the sliding mechanism 200 easily. The fixing hole 2213 is adjacent to the slide strips 223. The main plate 22 and the slide plate 21 may be metallic and made by punching.

The sliding mechanism 200 further includes a first limiting portion 225 and a second limiting portion 226. The first limiting portion 225 extends from a first end of the main plate 22, and the second limiting portion 226 extends from a second end of the main plate 22 opposite to the first end of the main plate 22. The first limiting portion 225 and the second limiting portion 226 are configured to restrict a sliding range of the slide plate 21. In the illustrated embodiment, the sliding mechanism includes two first limiting portions 225 and two second limiting portions 226.

The clock spring 23 includes a first spiral portion 235, a second spiral portion 236, and a connecting portion 238 connecting the first spiral portion 235 to the second spiral portion 236. A cross-section of the clock spring 23 may be circular, rectangular, or elliptical. The connecting portion 238 may be substantially curved. The first spiral portion 235 is positioned symmetrically to the second spiral portion 236. The coil direction of the first spiral portion 235 is opposite to the coil direction of the second spiral portion 238. The first spiral portion 235 has a first free end 2311, and the second spiral portion 236 has a second free end 2321. The first free end 2311 and the second free end 2321 are substantially ring-shaped.

The guiding rails 24 may be substantially rectangular shaped. A first sidewall (not labeled) forms a latching protrusion 242, and a second sidewall (not labeled) opposite to the first sidewall defines a guiding slot 244. The guiding rails 24 may be integrally formed with the slide plate 21 by an insert-molded technology. The slide plate 21, as an insert member, is inserted into an injection mold, and then melted plastic is injected into the injection mold to form the guiding rails 24 on the slide plate 21. In an insert-molding process, the melted plastic flows into the latching holes 2131 and the receiving grooves 213 of the slide plate 21. The melted plastic is joined around the latching holes 2131 to form a bonding structure for improving the bonding strength between the slide plate 21 and the guiding rails 24.

The sliding mechanism 200 further includes a first rivet 251 and a second rivet 252.

In assembly of the sliding mechanism 200, the first spiral portion 235 of the clock spring 23 is attached to the main plate 22, via the first rivet 251 engaging in the first free end 2311 and the fixing hole 2213 of the main plate 22. The second spiral portion 236 of the clock spring 23 is attached to the slide plate 21, by engaging the second rivet 252 in the second free end 2321 and the engaging hole 2113 of the slide plate 21. The clock spring 23 is positioned between the slide plate 21 and the main plate 22. The slide strips 223 of the main plate 22 are inserted into the guiding slots 244 of the corresponding guiding rails 24, so that the guiding rails 24 are slidably connected to the main plate 22. Accordingly, the slide plate 21 is slidable relative to the main plate 22 because the slide plate 21 is integrally formed with the guiding rails 24.

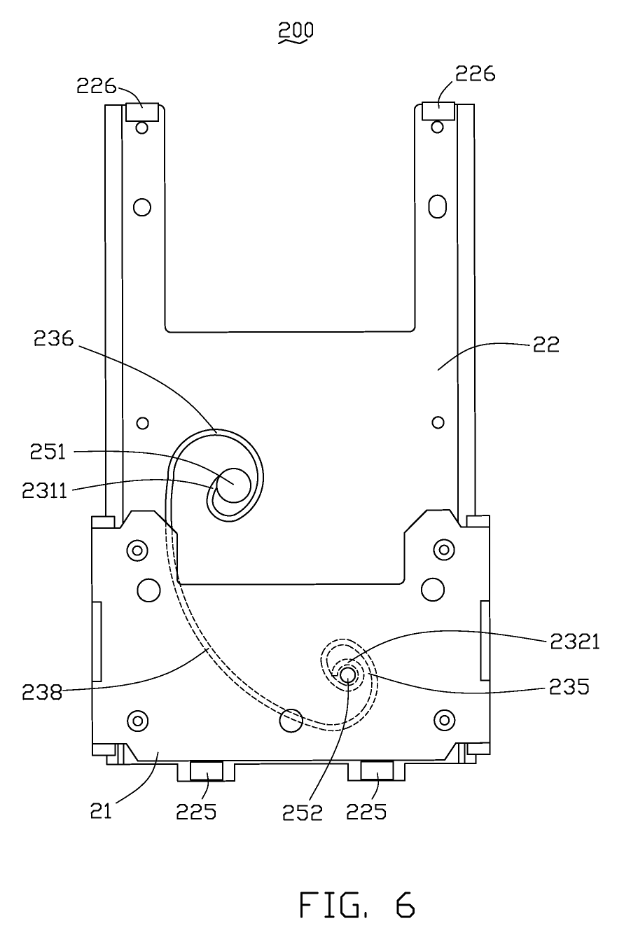

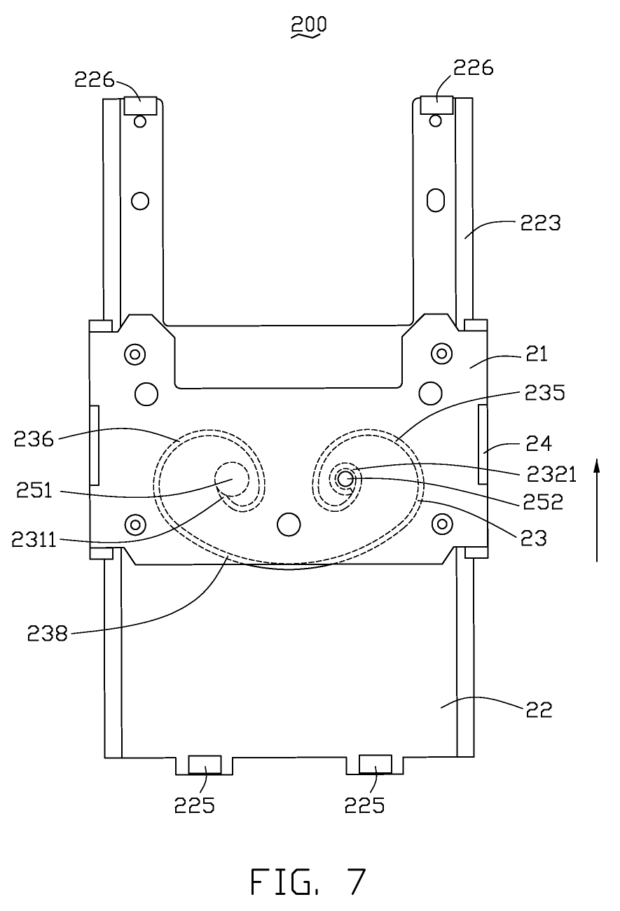

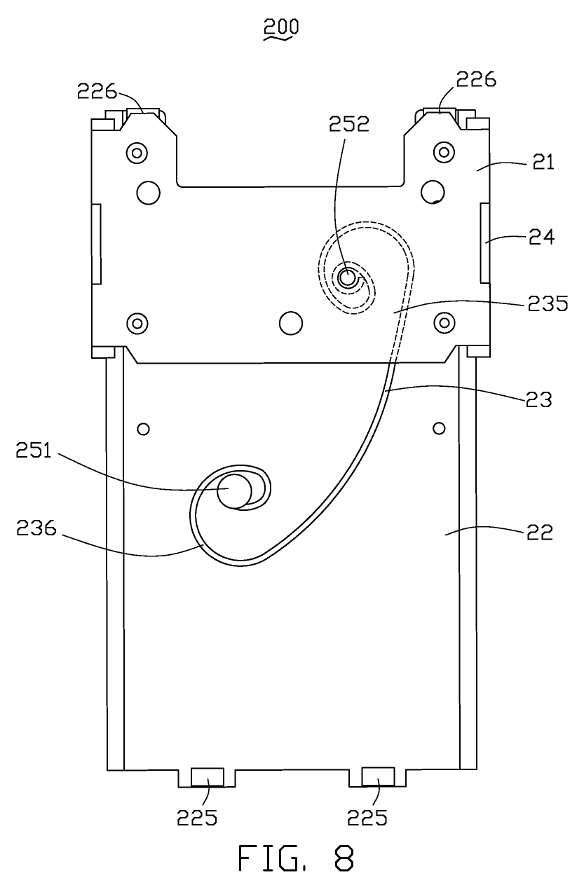

Referring to FIG. 1 again, when the sliding mechanism 200 is adopted in the portable electronic device 100, the first housing 102 of the portable electronic device 100 is firmly secured to the main plate 22, and the second housing 104 of the portable electronic device 100 is firmly secured to the slide plate 21. The portable electronic device 100 may be selectively opened or closed. FIG. 6 shows the slide plate 21 in one position, for example, a closed position, relative to the main plate 22. FIG. 7 shows the slide plate 21 in a half-closed position relative to the main plate 22. FIG. 8 shows the slide plate 21 in an open position relative to the main plate 22.

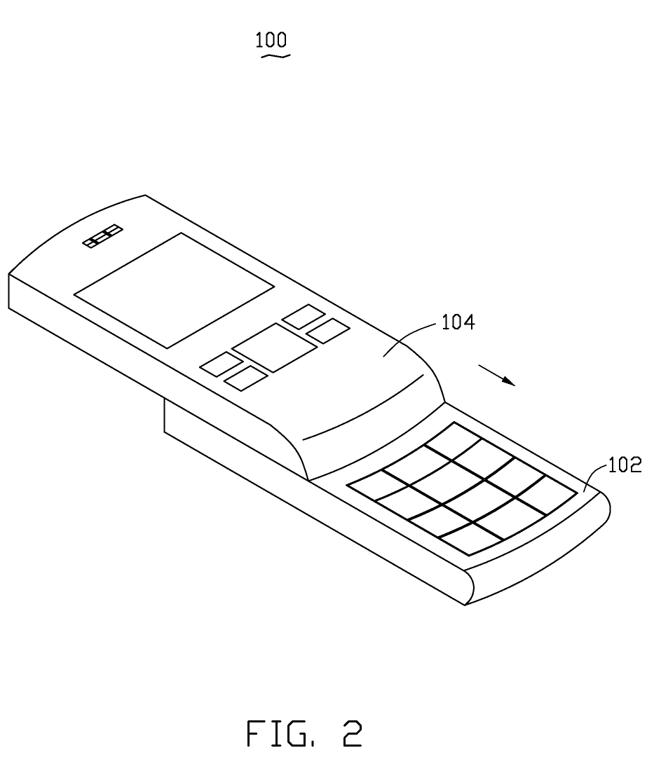

Referring to FIG. 6, the slide plate 21 is at an end of the main plate 22, the clock spring 23 is in a normal state, and a distance between the first and second free ends 2311, 2321 of the clock spring 23 is at the furthest distance. Referring also to FIG. 1, when the second housing 104 is moved along a direction of the arrow shown in FIG. 1, that is, towards an open position as shown in FIG. 2, the slide plate 21 slides relative to the main plate 22 as indicated by a direction of the arrow shown in FIG. 7. Therefore, the slide plate 21 together with the guiding rails 24 slide along the slide strips 223 of the main plate 22. The second free end 2321 moves towards the first free end 2311 of the clock spring 23. The distance between the first spiral portion 235 and the second spiral portion 236 decreases. The clock spring 23 is compressed, accumulating elastic force, and reaches the largest elastic force when the slide plate 21 reaches the middle of the main plate 22. In this position, the distance between the first spiral portion 235 and the second spiral portion 236 is at the smallest distance, and the curvature of the connecting portion 238 is at its largest.

As shown in FIG. 7, the clock spring 23 is at a largest compressed state when the slide plate 21 is in the middle of the main plate 22, thereby accumulating the largest elastic force. At this time, if the second housing 104 is pushed longitudinally in either direction away from the middle, the elastic force of the clock spring 23 is released along the direction of movement and the slide plate 21 slides in the direction urged by the elastic force of the clock spring 23 to either the open position of FIG. 6 or the closed position of FIG. 8.

When moving the slide plate 21 to the open or close position, the first spiral portion 235 and the second spiral portion 236 of the clock spring 23 simultaneously compresses, and then the first spiral portion 235 and the second spiral portion 236 simultaneously decompresses. In this way, the force applied on the clock spring 23 is distributed evenly on the clock spring 23, thereby preventing a stress concentration.

The sliding mechanism 200 has many advantages. One advantage is that the clock spring 23 includes a first spiral portion 235 and a second spiral portion 236. When the clock spring 23 is compressed, the external force applied on the clock spring 23 is distributed evenly on the whole clock spring 23. Therefore, the life of the clock spring 23 is prolonged. Another advantage is that the clock spring 23 is on a same plane. Thus, the clock spring 23 occupies a relatively small space. Lastly, since the guiding rails 24 are integrally formed with the slide plate 21, the sliding of the guiding rails 24 and the slide plate 21 is stable.

It is believed that the present embodiments and their advantages will be understood from the foregoing description, and it will be apparent that various changes may be made thereto without departing from the spirit and scope of the embodiments or sacrificing all of its material advantages, the examples hereinbefore described merely being preferred or exemplary embodiments.

What is claimed is:

1. A sliding mechanism, comprising:
a main plate;
a slide plate slidably connected to the main plate; and
a clock spring positioned between the main plate and the slide plate, the clock spring being configured for driving the slide plate and enabling the slide plate to slide along the main plate after the slide plate is manually moved to a predetermined position with respect to the main plate, the clock spring comprising:
a first spiral portion being fixed to the slide plate;
a second spiral portion being fixed to the main plate; and
a connecting portion connecting the first spiral portion to the second spiral portion.

2. The sliding mechanism of claim 1, wherein the coil direction of the first spiral portion is opposite to the coil direction of the second spiral portion.

3. The sliding mechanism of claim 2, wherein the clock spring is on substantially the same plane as the main plate and the slide plate; the first spiral portion is positioned symmetrically to the second spiral portion.

4. The sliding mechanism of claim 1, wherein the first spiral portion is fixed to the slide plate via a first rivet, and the second spiral portion is fixed to the main plate via a second rivet.

5. The sliding mechanism of claim 1, wherein a cross-section of the clock spring is circular, rectangular, or elliptical.

6. The sliding mechanism of claim 1, wherein the sliding mechanism further comprises a pair of guiding rails; the slide plate defines two receiving grooves in opposite sides thereof; the main plate includes a pair of slide strips in opposite sides thereof; the guiding rails engage in the corresponding receiving grooves of the slide plate; the slide strips of the main plate engage with the guiding rails.

7. The sliding mechanism of claim 6, wherein the guiding rails are integrally formed with the slide plate.

8. The sliding mechanism of claim 1, wherein the sliding mechanism further comprises a first limiting portion fixed to a first end of the main plate and a second limiting portion fixed to a second end of the main plate opposite to the first end.

9. A portable electronic device, comprising:
a first housing;
a second housing slidably connected to the first housing; and
a sliding mechanism connected between the first housing and the second housing for guiding a sliding motion of the second housing relative to the first housing, the sliding mechanism comprising:
a main plate secured to the first housing;
a slide plate slidably connected to the main plate, and secured to the second housing; and
a clock spring positioned between the main plate and the slide plate, the clock spring being configured for driving the slide plate and enabling the slide plate to slide along the main plate after the slide plate is manually moved to a predetermined position with respect to the main plate, the clock spring comprising:
a first spiral portion being fixed to the slide plate;
a second spiral portion being fixed to the main plate; and
a connecting portion connecting the first spiral portion to the second spiral portion.

10. The portable electronic device of claim 9, wherein the coil direction of the first spiral portion is opposite to the coil direction of the second spiral portion.

11. The portable electronic device of claim 10, wherein the clock spring is on substantially the same plane as the main plate and the slide plate, and the first spiral portion is positioned symmetrically to the second spiral portion.

12. The portable electronic device of claim 9, wherein the first spiral portion is fixed to the slide plate via a first rivet, and the second spiral portion is fixed to the main plate via a second rivet.

13. The portable electronic device of claim 9, wherein a cross-section of the clock spring is circular, rectangular, or elliptical.

14. The portable electronic device of claim 9, wherein the sliding mechanism further comprises a pair of guiding rails; the slide plate defines two receiving grooves in opposite sides thereof; the main plate includes a pair of slide strips in opposite sides thereof; the guiding rails engage in the corresponding receiving grooves of the slide plate; the slide strips of the main plate engage with the guiding rails.

15. The portable electronic device of claim 14, wherein the guiding rails are integrally formed with the slide plate.

16. The portable electronic device of claim 9, wherein the sliding mechanism further comprises a first limiting portion fixed to a first end of the main plate and a second limiting portion fixed to a second end of the main plate opposite to the first end.
